(19) United States
(12) Patent Application Publication
(10) Pub. No.: US 2016/0006224 A1
(43) Pub. Date: Jan. 7, 2016

(54) DISMANTLABLE INSULATOR FOR GAS INSULATED SWITCHGEAR

(71) Applicant: SIEMENS AKTIENGESELLSCHAFT, München (DE)

(72) Inventor: Jin Feng WANG, Xiamen (CN)

(21) Appl. No.: 14/767,813

(22) PCT Filed: Mar. 7, 2014
(86) PCT No.: PCT/EP2014/054431

§ 371 Date: Aug. 13, 2015

(30) Foreign Application Priority Data
Mar. 15, 2013 (CN) 201310084284.2

(51) Int. Cl. H02B 13/045

(52) U.S. Cl. CPC H02B 13/045

(57) ABSTRACT

A dismantlable insulator is disclosed including a flange and an insulating body mated with the flange. The insulating body and the flange are separate in structure, and the insulating body is fitted inside the flange via multiple fixing elements. The flange is integrally formed with a housing of gas insulated switchgear, and has a radial projection which projects radially inward, an inner end face of the insulating body being in contact with the radial projection. The dismantlable insulator of an embodiment of the present invention can reduce gaps between the insulating body and the flange, increase the rate of end product acceptability and reduce production costs.

### PRIORITY STATEMENT

This application is the national phase under 35 U.S.C. §371 of PCT International Application No. PCT/EP2014/054431 which has an International filing date of Mar. 7, 2014, which designated the United States of America and which claims priority to Chinese patent application number CN 2013100842842 filed Mar. 15, 2013, the entire contents of which are hereby incorporated herein by reference.

### FIELD

At least one embodiment of the present invention generally relates to an insulator, in particular to a dismantlable insulator for gas insulated switchgear.

### BACKGROUND

An insulator is a special insulating element, which can serve an insulating and supporting function in high voltage power transmission circuits. In particular, it plays a vital role in gas insulated switchgear (abbreviated as GIS).

At the present time, insulators used in GIS generally include a metal flange and an insulating body. There is a gap between the insulating body and the external flange. Since the gap is at the edge of the insulator, manufacturing defects readily occur at this position, and owing to the presence of the gap, it is very easy for all kinds of impurities, dust and metal chippings, etc. to fall into the gap during production, assembly or transportation. Thus, in the course of long-term operation, local discharge threatening system operation will be increased in these parts, resulting in a hidden danger with a huge effect on system operation.

In view of this, in order to reduce the problem caused by the gap between the insulating body and flange, technical personnel thought of achieving a seamless fixed connection between the insulating body and flange by casting the insulating body in the flange. Casting is generally regarded as the best technological means of achieving a seamless fixed connection. In the case of an insulator cast in one piece, the metal flange must undergo a series of processes including sandblasting and cleaning prior to casting, which will increase both costs and the process complexity.

However, the insulator and metal flange cannot be disassembled after casting is complete, and the insulating body in the middle readily experiences deformation in the form of contraction during casting, causing the gap between the insulating body and the flange to increase. Thus to solve the gap problem caused by the casting process itself, technical personnel have made many improvements to the casting process itself, as well as to the shape of the insulator and flange. Examples are improvements to the joining faces of the insulating body and flange, to increase the degree of mating therebetween.

The description of Chinese utility model patent CN 202145396 U has disclosed a fastening flange for a disk insulator. Locking grooves are distributed uniformly on an inside face of the flange; communication holes connecting upper and lower end faces of the flange are provided on the flange, with a communication hole being provided between each pair of locking grooves; three fastening holes are provided on the flange, the fastening holes being disposed inside locking grooves and connecting inside and outside faces of the flange; and bolts are provided in the fastening holes. The locking grooves on the flange result in increased tightness between the insulating body and flange when casting.

However, no matter what kind of casting process is used to make the insulator, the insulating body in the middle will deform by contracting. During the casting process, technologically there is no way of controlling defects and gaps at the casting interface of the insulating body and flange, with the result that the rate of end product acceptability for insulators is reduced and the risk of local discharge is increased, increasing costs. This also makes it difficult to test for various defects at the casting interface of the insulating body and flange, resulting in a hidden safety hazard. Even if the defect is detected between the insulating body and the flange, the entire insulator must be discarded, which will also result in increased costs.

### SUMMARY

A dismantlable insulator for gas insulated switchgear is disclosed in at least one embodiment, which is capable of lowering costs, reducing the problem caused by the gap between the insulating body and flange, and reducing the presence of defects on the gap surfaces.

A dismantlable insulator for gas insulated switchgear, of at least one embodiment, comprises a flange and an insulating body mated with the flange, the insulating body and the flange being separate in structure, and the insulating body being fitted inside the flange by way of multiple fixing elements, wherein the flange is integrally formed with a housing of gas insulated switchgear, and has a radial projection which projects radially inward, an inner end face of the insulating body being in contact with the radial projection. Testing of the insulating body and flange shows that they meet predetermined quality standards, and match each other.

### BRIEF DESCRIPTION OF THE DRAWINGS

The accompanying drawings below are intended merely to illustrate and explain the present invention schematically, and by no means limit the scope thereof. In the drawings,

FIG. 1 is a three-dimensional schematic diagram of one embodiment of the dismantlable insulator of the present invention;

FIG. 2 is a side view of the dismantlable insulator of one embodiment of the present invention shown in FIG. 1;

FIG. 3 is a sectional drawing along the line A-A in FIG. 2 of one embodiment of the dismantlable insulator of the present invention;

FIG. 4 is a sectional drawing along the line B-B in FIG. 2 of one embodiment of the dismantlable insulator of the present invention;

FIG. 5 is a three-dimensional schematic diagram of the flange in one embodiment of the dismantlable insulator of the present invention;

FIG. 6 is a three-dimensional schematic diagram of the insulating body in one embodiment of the dismantlable insulator of the present invention.

Key to labels used for main apparatus
1 housing
2 sealing cap
3 insulating body
4 buffer ring
5 flange
6 sealing hole
7 conductive post
8 fixing hole
9 joining face of insulating body
10 dismantlable insulator
11 joining face of flange
12 annular protrusion
13 annular groove
14 radial projection
15 first sealing ring
16 second sealing ring
17 slot
18 outside face of flange
19 through-slot
20 third sealing ring

### DETAILED DESCRIPTION OF EXAMPLE EMBODIMENTS

A dismantlable insulator for gas insulated switchgear, of at least one embodiment, comprises a flange and an insulating body mated with the flange, the insulating body and the flange being separate in structure, and the insulating body being fitted inside the flange by way of multiple fixing elements, wherein the flange is integrally formed with a housing of gas insulated switchgear, and has a radial projection which projects radially inward, an inner end face of the insulating body being in contact with the radial projection. Testing of the insulating body and flange shows that they meet predetermined quality standards, and match each other.

The separate manufacture and assembly of the flange and insulating body reduces the complexity of each manufacturing process, enabling batch production of the flange and insulating body, and helping to increase the rate of end product acceptability of each separate process. Moreover, if a single component is damaged, it can be replaced on its own, and maintenance and manufacturing costs can be reduced.

The flange can be made of metal, preferably aluminum, while the insulating body can be made of resin. In a preferred embodiment, the insulating body is disk-shaped, while the flange is round; a side face of the insulating body is the joining face thereof, while an inside face of the flange is the joining face thereof. Having the housing and flange integrally formed enables manufacturing costs to be reduced; moreover, when the flange and housing are integrally formed, a better seal is achieved therebetween, averting leakage of insulating gas.

Preferably, a buffer ring is disposed between the insulating body and the radial projection. The buffer ring can reduce shock to the epoxy resin surface during installation or a fault (e.g. a pressure change on one side).

Preferably, a through-slot is included on an inner end face of the insulating body, and insulating gas can bypass the buffer ring via the through-slot to enter a gap between a joining face of the flange and a joining face of the insulating body. The through-slot enables pressurized gas, e.g. SF6 gas, to bypass the buffer ring and enter the gap between the joining face of the flange and the joining face of the insulating body, thereby reducing the risk of local discharge at the gap, to ensure safety and stability of the insulating element in long-term operation.

Preferably, the insulating body comprises at least one conductive post penetrating an inner end face and outer end face of the insulating body, the insulating body and the conductive post being an integrally formed structure, a side face of the conductive post having an annular protrusion, and the insulating body having an annular groove corresponding to the annular protrusion. There may be a single conductive post, preferably positioned in the center of the insulating body; there may also be two or more conductive posts, preferably distributed symmetrically at the center of the insulating body. The two end faces of the conductive post may have joining holes, to facilitate connection with external leads. Since the conductive post is integrally formed with the insulating body, the manufacturing process is simple and can make the union of the two tight. In another preferred embodiment, the center of the insulating body may be hollow, facilitating direct passage of a high-voltage busbar through the center of the insulating body, with the insulating body serving to support and insulate the busbar.

Preferably, the flange has multiple sealing holes running through the joining face and an outside face of the flange, while the joining face of the insulating body is provided with slots in a one-to-one correspondence with the sealing holes. The annular protrusion on the conductive post increases the area of direct contact between the conductive post and the insulating body so that contact therebetween is tighter, and the fixing is more reliable.

Preferably, the fixing element is a sealing cap, one end of the sealing cap being inserted into the slot and sealing hole, a third sealing ring being provided between the sealing cap and the sealing hole, and the other end of the sealing cap being fixed to the outside face of the flange by screws. The sealing caps allow better locking together of the flange and the insulating body, averting rotation of the flange and insulating body around the center, and hence fixing the flange and insulating body together more tightly. At the same time, the sealing caps and sealing rings can avert leakage of pressurized gas to the outside via the sealing holes.

Preferably, a first sealing ring is disposed on the outer end face of the insulating body.

Preferably, the flange is provided with a second sealing ring in the same plane as the first sealing ring. The first sealing ring and second sealing ring further ensure sealing between the flange and external apparatus.

Particular embodiments of the present invention are now explained with reference to the accompanying drawings, in order that the technical features, object and effects of the present invention may be understood more clearly.

In the embodiments of the present invention, for convenience of presentation, the boundary faces of the insulating body and of the flange which come into contact with each other are referred to as the joining face of the insulating body and the joining face of the flange, respectively. The “inner end face” and “outer end face” referred to below correspond to structural positions after assembly of the insulator in the accompanying drawings, and by no means serve to define the structure of the present invention.

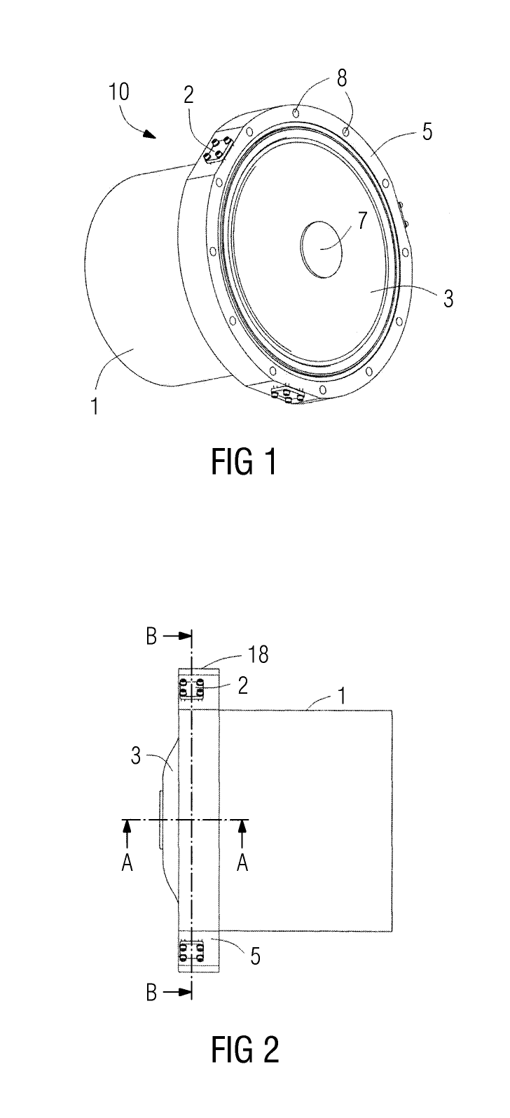

FIG. 1 is a three-dimensional schematic diagram of one embodiment of the dismantlable insulator of the present invention. As FIG. 1 shows, the dismantlable insulator 10 comprises a flange 5, an insulating body 3 and a housing 1. The flange 5 is annular, while the insulating body 3 is disk-shaped. The insulating body 3 is inserted in the flange 5 and mated therewith. A cylindrical conductive post 7 is provided in the center of the insulating body 3, the conductive post 7 penetrating an inner end face (the end face adjacent to the housing 1, not shown in the figure) and outer end face of the insulating body 3, and the conductive post 7 and insulating body 3 are an integrally formed structure. Twelve fixing holes 8 are provided on an annular outer side of the flange 5; the fixing holes 8 are distributed symmetrically on the annular outer side of the flange 5, and run through both end faces of the flange 5. This facilitates insertion of bolts during installation and fixing to external apparatus. In other embodiments, there may be any number of fixing holes, more than or less than twelve, as long as the relevant technical requirements can be met. Preferably, all the fixing holes are distributed symmetrically on the flange; this enables a single pressure to be exerted uniformly on the entire flange during actual assembly, so that the flange can be connected to external apparatus more tightly.

FIG. 2 is a side view of the dismantlable insulator of an embodiment of the present invention shown in FIG. 1. As FIG. 2 shows, there are three sealing caps 2 on an outside face 18 of the flange 5, wherein one sealing cap (not shown in the figure) is located behind the two sealing caps 2 shown in the figure. The sealing caps 2 are fixed by screws to the outside face 18 of the flange 5.

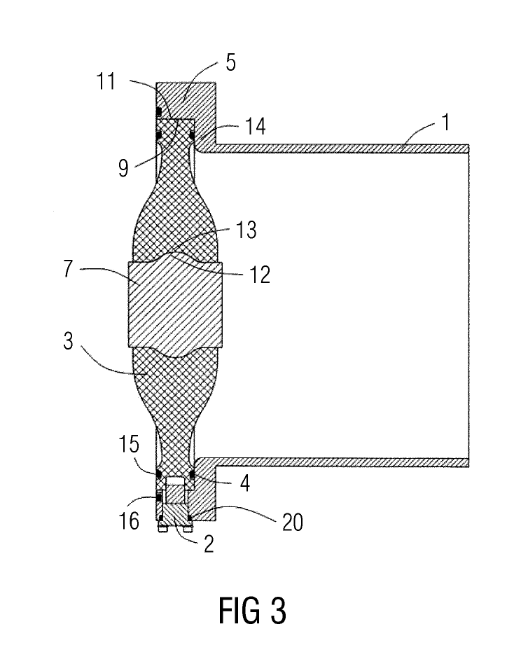

FIG. 3 is a sectional drawing along the line A-A in FIG. 2 of one embodiment of the dismantlable insulator of the present invention. As FIG. 3 shows, the dismantlable insulator 10 comprises a flange 5 and an insulating body 3 mated with the flange 5, the insulating body 3 being fixed in the flange 5 by means of sealing caps 2. In the middle of the insulating body 3 is a conductive post 7 which penetrates both end faces of the insulating body 3. A side face of the conductive post 7 has an annular protrusion 12, while the insulating body 3 has an annular groove 13 matched to the annular protrusion 12. Only one annular protrusion 12 is shown in the figure; in other embodiments which are not shown, the number of annular protrusions 12 need not be limited to one, but may be more than one, wherein the shape of the annular protrusion 12 is by no means limited to an arc, but may also be triangular, round, rectangular, trapezoidal, fan-shaped or of a shape formed by a combination thereof.

In other embodiments, there may be an even or odd number of multiple conductive posts, distributed symmetrically on the insulating body, or distributed uniformly in the circumferential direction of the insulator. In another preferred embodiment, the center of the insulating body 3 may be hollow, so that in the course of actual implementation, a busbar can be passed directly through the center of the insulating body, which then serves to insulate and support the busbar.

In FIG. 3, a joining face 11 of the flange 5 has a radial projection 14 which projects radially inward. The radial projection 14 is annular, and during assembly of the flange 5 and insulating body 3, the insulating body 3 is inserted into the flange 5 such that the insulating body 3 comes into contact with the radial projection 14 of the flange 5. To provide better sealing for the sulfur hexafluoride insulating gas (not shown in the figure) filling the region between the insulating body 3 and the housing 1, in a preferred embodiment a buffer ring 4 is disposed between the contact boundary faces of the inner end face of the insulating body 3 and the radial projection 14 of the flange 5. The buffer ring 4 can reduce shock to the epoxy resin surface during installation or a fault (e.g. a pressure change on one side).

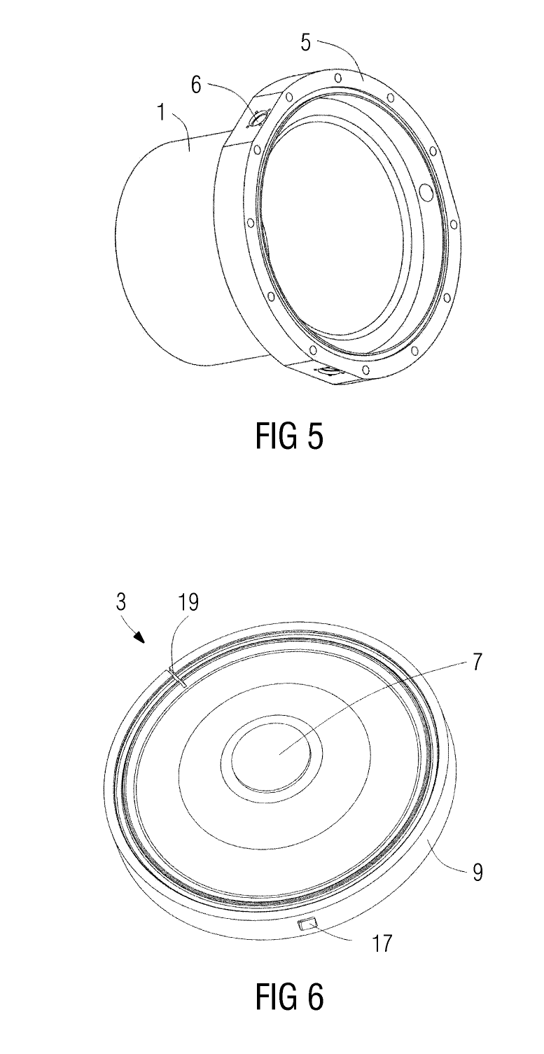

In another preferred embodiment, a through-slot 19 is included on the inner end face of the insulating body 3 (as shown in FIG. 6). Insulating gas can bypass the buffer ring 4 via the through-slot 19 to enter a gap between the joining face 11 of the flange and a joining face 9 of the insulating body. The through-slot 19 enables pressurized gas, e.g. SF6 gas, to bypass the buffer ring 4 and enter the gap between the joining face 11 of the flange and the joining face 9 of the insulating body, thereby reducing the risk of local discharge at the gap, to ensure safety and stability of the insulating element in long-term operation. A first sealing ring 15 is disposed on the outer end face (the end face remote from the housing 1, i.e. the left-hand side face shown in the figure) of the insulating body 3, and the flange 5 also has a second sealing ring 16 which lies in the same plane as the first sealing ring 15. The buffer ring 4, first sealing ring 15 and second sealing ring 16 are separate and can be removed from the flange and insulating body. The material is preferably a macromolecular substance exhibiting elasticity. No specific restrictions are imposed here.

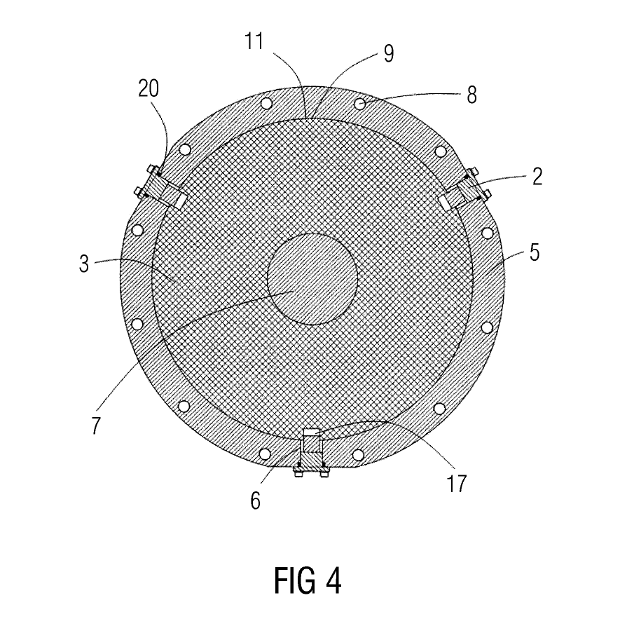

FIG. 4 is a sectional drawing along the line B-B in FIG. 2 of one embodiment of the dismantlable insulator of the present invention. As FIG. 4 shows, the dismantlable insulator 10 comprises a flange 5 and an insulating body 3 mated with the flange 5, the joining face 9 of the insulating body 3 being in contact with the joining face 11 of the flange 5. FIG. 4 shows two mutually overlapping side faces; it shows a circle. On the flange 5 are three sealing holes 6 which run through the joining face 11 and outside face 18 of the flange 5, the three sealing holes 6 being distributed on the circumference of the flange 5 uniformly in the circumferential direction. Similarly, on the joining face 9 of the insulating body 3 are three slots 17.

There is a one-to-one correspondence between the positions of the three slots 17 and the positions of the three sealing holes 6, wherein one end of each sealing cap 2 is inserted into a slot 17 and sealing hole 6, serving the function of immobilizing the insulating body 3 and the flange 5; a third sealing ring 20 is provided between each sealing cap 2 and sealing hole 6, and the other end of each sealing cap 2 is fixed to the outside face 18 of the flange 5. At the same time, the sealing caps 2 and third sealing rings 20 can avert leakage of pressurized gas to the outside through the sealing holes 6, wherein the sealing caps 2 are preferably made from metal. Those skilled in the art will know that in other embodiments, there may be any number of sealing holes and slots, as long as the relevant technical requirements can be met. The number of sealing holes may be equal to or different from the number of slots, i.e. there may or may not be a one-to-one correspondence therebetween; the sealing holes and slots may be distributed on the respective circumferences of the flange and the insulating body uniformly in the circumferential direction, or may be distributed randomly on the respective circumferences of the flange and the insulating body. Preferably, the sealing holes, slots and sealing caps correspond to one another in a one-to-one fashion, and are distributed symmetrically on the flange circumference.

FIG. 5 is a three-dimensional schematic diagram of the flange in one embodiment of the dismantlable insulator of the present invention; FIG. 6 is a three-dimensional schematic diagram of the insulating body in one embodiment of the dismantlable insulator of the present invention. As shown in FIGS. 5 and 6, the dismantlable insulator comprises a flange 5 and an insulating body 3, wherein the insulating body 3 and flange 5 are separate in structure. Multiple sealing holes 6 are provided in the flange 5, and multiple slots 17 are provided in the joining face 9 of the insulating body 3. As shown in FIG. 5, the flange 5 is connected to the housing 1, wherein the flange 5 and housing 1 are an integrally formed structure. In actual embodiments, the flange 5 and housing 1 can be manufactured by being formed in one piece. The airtightness between a housing and flange manufactured in this way will be extremely good, and capable of preventing leakage of insulating gas effectively. Moreover, the required flange and housing can be manufactured in one step, shortening the process and reducing costs. The shape of the housing is determined according to the requirements of fixing and fitting to the external environment, and a variety of housing shapes are possible. Production costs can be reduced by having the housing and flange formed in one piece.

Before the insulator of an embodiment of the present invention is assembled, the insulating body and flange are subjected to a variety of tests, for instance measurements of the size and shape of the flange, and of the smoothness, cleanliness and surface quality of the flange joining face, measurements of the size and shape of the insulating body, and of the smoothness, cleanliness and internal quality of the insulating body joining face, as well as tests to determine whether the insulating body matches the flange. By testing the flange and insulating body, all kinds of defects and gaps between the insulating body and flange can be found relatively easily, and all assembled dismantlable insulators can be guaranteed to meet the required standards. It is also possible to discover whether there are any metal particles or dust on the flange and insulating body, so that this can be dealt with promptly before assembly, and hidden dangers in the assembled insulator can be avoided; the rate of end product acceptability for each insulator can also be increased. When an insulating body is a substandard product, it need only be replaced with another product, so that costs are reduced. The insulator of the present invention will not become a defective product as a result of defects such as cracks, or dust or metal particles in gaps.

It should be appreciated that although the description herein is presented in terms of various embodiments, it is certainly not the case that each embodiment only contains one independent technical solution. This method of presentation is used purely for the sake of clarity. Those skilled in the art should take the description as a whole; the technical solutions in different embodiments may also be suitably combined to form other embodiments which those skilled in the art could understand.

The above embodiments are merely particular illustrative embodiments of the present invention, and are by no means intended to define the scope thereof. Any equivalent changes, amendments and combinations made by those skilled in the art without departing from the concept and principles of the present invention should fall within the scope of protection thereof.

1. A dismantlable insulator for gas insulated switchgear, comprising:
a flange and
an insulating body mated with the flange, the insulating body and the flange being separate in structure, and the insulating body being fitted inside the flange via multiple fixing elements, the flange being integrally formed with a housing of the gas insulated switchgear, and including a radial projection projecting radially inward, and an inner end face of the insulating body being in contact with the radial projection.

2. The dismantlable insulator of claim 1, wherein a buffer ring is disposed between the insulating body and the radial projection.

3. The dismantlable insulator of claim 2, wherein a through-slot is included on an inner end face of the insulating body, and insulating gas can bypass the buffer ring via the through-slot to enter a gap between a joining face of the flange and a joining face of the insulating body.

4. The dismantlable insulator of claim 2, wherein the insulating body comprises at least one conductive post penetrating an inner end face and outer end face of the insulating body, the insulating body and the conductive post being an integrally formed structure, a side face of the conductive post including an annular protrusion, and the insulating body including an annular groove corresponding to the annular protrusion.

5. The dismantlable insulator of claim 3, wherein the flange includes multiple sealing holes running through a joining face and an outside face of the flange, and wherein the joining face of the insulating body is provided with slots in a one-to-one correspondence with the sealing holes.

6. The dismantlable insulator of claim 5, wherein the fixing element is a sealing cap, one end of the sealing cap being inserted into the slot and the sealing hole, a third sealing ring being provided between each of the sealing caps and the sealing holes, and the other end of the sealing cap being fixed to the outside face of the flange by screws.

7. The dismantlable insulator claim 1, wherein a first sealing ring is disposed on the outer end face of the insulating body.

8. The dismantlable insulator of claim 7, wherein the flange is provided with a second sealing ring in the same plane as the first sealing ring .

9. The dismantlable insulator of claim 2, wherein a first sealing ring is disposed on the outer end face of the insulating body.

10. The dismantlable insulator of claim 9, wherein the flange is provided with a second sealing ring in the same plane as the first sealing ring.

11. The dismantlable insulator of claim 3, wherein a first sealing ring is disposed on the outer end face of the insulating body.

12. The dismantlable insulator of claim 11, wherein the flange is provided with a second sealing ring in the same plane as the first sealing ring.

13. The dismantlable insulator of claim 4, wherein a first sealing ring is disposed on the outer end face of the insulating body.

14. The dismantlable insulator of claim 13, wherein the flange is provided with a second sealing ring in the same plane as the first sealing ring.

15. The dismantlable insulator of claim 5, wherein a first sealing ring is disposed on the outer end face of the insulating body.

16. The dismantlable insulator of claim 15, wherein the flange is provided with a second sealing ring in the same plane as the first sealing ring.

17. The dismantlable insulator of claim 6, wherein a first sealing ring is disposed on the outer end face of the insulating body.

18. The dismantlable insulator of claim 17, wherein the flange is provided with a second sealing ring in the same plane as the first sealing ring.
